(19) United States
(12) Patent Application Publication
(10) Pub. No.: US 2010/0131359 A1
(43) Pub. Date: May 27, 2010

(54) SYSTEM AND METHOD FOR SECURING INVOCATIONS FOR SERVING ADVERTISEMENTS AND INSTRUMENTATION IN ONLINE ADVERTISING

(75) Inventors: Chyr-Chong Joseph Ting, San Jose, CA (US); Chyr-Song Ting, San Marcos, CA (US)

Correspondence Address: Law Office of Robert Bolan, P.O. Box 36, Bellevue, WA, 98009, US

(73) Assignee: Yahoo! Inc., Sunnyvale, CA (US)

(21) Appl. No.: 12/324,786

(22) Filed: Nov. 26, 2008

(51) Int. Cl. G06F 21/24; H04L 9/28; G06Q 30/00

(52) U.S. Cl. 705/14.47; 726/27; 713/193

(57) ABSTRACT

An improved system and method for securing invocations for serving advertisements and instrumentation in online advertising is provided. An advertisement exchange server may provide services for publisher servers to add executable instructions to securely display online advertisements on a client device within allocated space of a web page of content published by the publisher servers. A client device may retrieve a document with added executable instructions and execute the executable instructions that may calculate a checksum, extract the internet protocol address of the publisher server, and send a request with the checksum and internet protocol address of the publisher server to retrieve an advertisement to display with content of the document. The advertisement exchange server may verify that the checksum is valid for the internet protocol address of the publisher server and may send the request to an advertiser server to serve an advertisement to the client device.

### FIELD OF THE INVENTION

The invention relates generally to computer systems, and more particularly to an improved system and method for securing invocations for serving advertisements and instrumentation in online advertising.

### BACKGROUND OF THE INVENTION

Current advertisement serving platforms, such as AdSense and the Yahoo Publisher Network, allow publishers' websites to display advertisements for participating advertisers. A publisher may register for an account and an application may create an advertisement tag to be placed on the web pages of the website owned by the publisher. The advertisement tag is typically a javascript, but may be any type of executable instructions that can be added to a web page. When a browser retrieves and loads the web page on a client device, the advertisement tag makes an invocation to an advertisement serving platform to get an advertisement. The advertiser is charged based on some pricing type such as cost per thousand of impressions (CPM), cost per click (CPC), cost per action (CPA) or other pricing type. The publisher is paid based on some revenue share or pricing type.

Unfortunately, a malicious user can steal the advertisement tag by viewing the source code in a browser and improperly use the advertisement tag to generate unintended requests to the advertisement serving platform. For instance, a malicious user can place the advertisement tag on a website with offensive content. Or a malicious user can place a conversion tag on an unintended website to send false conversion notifications to the advertisement serving platform. As a result, publishers are constantly monitored by advertisement serving platforms for potentially harmful content and also fake advertisement calls to advertisement servers. An advertisement serving platform may implement an automated mechanism to check the quality of a website to detect an offensive website. And advertisements may be blocked for offensive websites detected. This inhibits revenue generation by publishers and advertisement serving platforms.

What is needed is a way to securely serve online advertisements for publishers' websites. Such a system and method should be able to identify that the advertisement tag is genuine and belongs to the registered publisher.

### SUMMARY OF THE INVENTION

The present invention provides a system and method for securing invocations for serving advertisements and instrumentation in online advertisements. An advertisement exchange server may provide services for publisher servers to add executable instructions to securely display online advertisements on a client device within allocated space of a web page of content published by the publisher servers. The advertisement exchange server may include an advertisement exchange application that may receive requests for executable instructions that may be included in an HTML document to retrieve and display advertisements with web page content. The advertisement exchange server may also include an executable code generator that provides the executable instructions, a checksum calculator that calculates a checksum from the binary values of the executable instructions, and a code verifier that validates the checksum of the advertisement executable instructions and the internet protocol (IP) address of the publisher server.

A publisher server may request and receive executable instructions that may retrieve and display advertisements with web page content. The executable instructions may also calculate a checksum to validate the executable instructions. The publisher server may add the executable instructions in a Hypertext Markup Language (HTML) document and store the document on the publisher server. A client device may then retrieve the document and execute the executable instructions. The executable instructions may calculate a checksum from the binary values of the executable instructions, extract the internet protocol address of the publisher server, and send a request with the checksum and internet protocol address of the publisher server to the advertisement exchange server to retrieve an advertisement to display with content of the document. The advertisement exchange server may receive the request from the client device and verify that the checksum is valid for the internet protocol address of the publisher server by comparing the checksum received with the checksum stored for the internet protocol address of the publisher server. The advertisement exchange server may then send the request to an advertiser server to serve an advertisement to the client device. In other embodiments, a client device may send the request with the checksum and the internet protocol address of the publisher server to the publisher server, and the publisher server may verify the checksum is valid and serve the advertisement to the client device.

An advertiser server may also use the present invention to track conversion of advertisements such as a purchase, registration, or other activity in response to display of an advertisement. An advertiser server may send a request to receive executable instructions that send notification of conversion from display of an advertisement on a computing device. The advertisement exchange server may receive the request, generate executable instructions that send notification of conversion from display of an advertisement, calculate a checksum from the binary values of the executable instructions, and send the executable instructions that send notification of conversion from display of an advertisement to the advertiser server. The advertiser server may add the executable instructions for sending a notification of conversion in an HTML document and store the document on the advertiser server. The advertisement exchange server may later receive a notification from a client device that retrieved the web page and verify that the checksum is valid for the internet protocol address of the advertiser server by comparing the checksum received with the checksum stored for the internet protocol address of the advertiser server.

The present invention may thus generally provide a mechanism to secure invocations of executable instructions including instrumentation in online advertising platforms. Various tracking and annotative functions on a client device including segmentation beaconing or engagement tracking for a web page or video advertising leveraging client-side instrumentation can use the mechanism of the present invention for increased security. The system and method may promote revenue generation by providing a more secure online advertising platform for publishers, advertisers, and advertisement exchange services. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for securely serving online advertisements, in accordance with an aspect of the present invention;

FIG. 3 is a flowchart for generally representing the steps undertaken in one embodiment for adding executable instructions in a web page for securely serving online advertisements, in accordance with an aspect of the present invention;

FIG. 4 is a flowchart for generally representing the steps undertaken in one embodiment for generating executable instructions for a web page to request and receive an advertisement for display on a computing device for securely serving online advertisements, in accordance with an aspect of the present invention;

FIG. 5 is a flowchart for generally representing the steps undertaken in one embodiment for invoking the executable instructions for a web page to request and receive an advertisement for display on a computing device for securely serving online advertisements, in accordance with an aspect of the present invention;

FIG. 6 is a flowchart for generally representing the steps undertaken in one embodiment for verifying a request to receive an advertisement for display on a computing device is valid for securely serving online advertisements, in accordance with an aspect of the present invention; and

FIG. 7 is a flowchart for generally representing the steps undertaken in one embodiment for generating executable instructions for a web page to securely send notification of conversion from display of an advertisement on a computing device, in accordance with an aspect of the present invention.

### DETAILED DESCRIPTION

### Exemplary Operating Environment

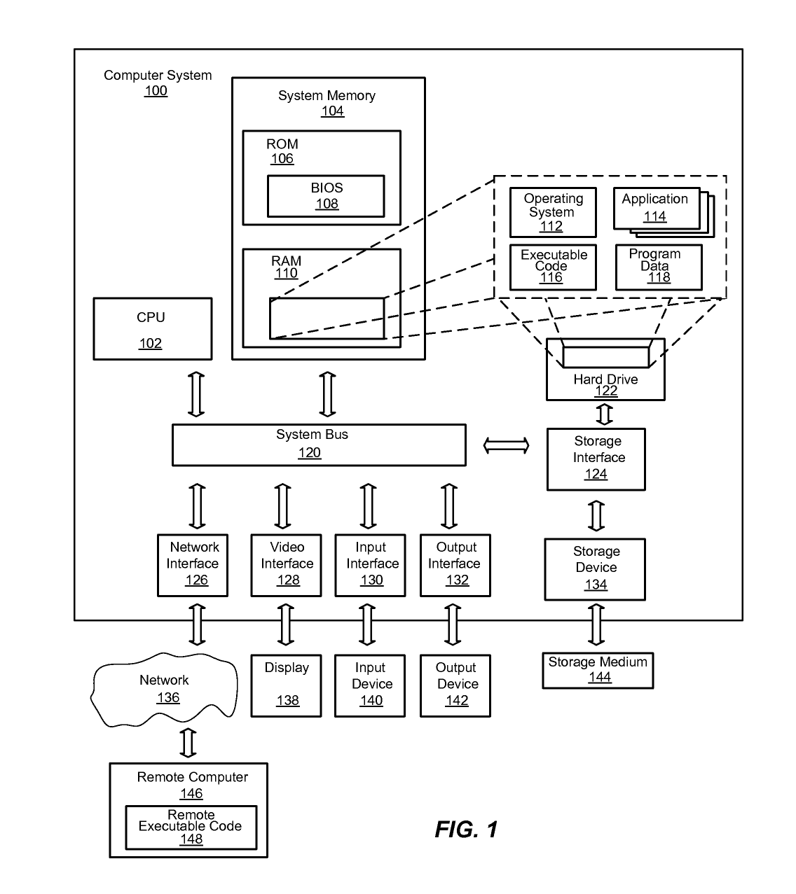

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used. Those skilled in the art will also appreciate that many of the components of the computer system 100 may be implemented within a system-on-a-chip architecture including memory, external interfaces and operating system. System-on-a-chip implementations are common for special purpose hand-held devices, such as mobile phones, digital music players, personal digital assistants and the like.

### Securing Invocations for Serving Advertisements and Instrumentation in Online Advertising

The present invention is generally directed towards a system and method for securing invocations for serving advertisements and instrumentation in online advertising. In an embodiment, an advertisement exchange server may provide services for publisher servers to add executable instructions to securely display online advertisements on a client device within allocated space of a web page of content published by the publisher servers. The publisher server may add the executable instructions in an HTML document and store the document on the publisher server. A client device may retrieve a document with added executable instructions and execute the executable instructions. The executable instructions may calculate a checksum, extract the internet protocol address of the publisher server, and send a request with the checksum and internet protocol address of the publisher server to the advertisement exchange server to retrieve an advertisement to display with content of the document. The advertisement exchange server may verify that the checksum is valid for the internet protocol address of the publisher server and may send the request to an advertiser server to serve an advertisement to the client device.

As will be seen, the present invention may also be used to track conversion of advertisements such as a purchase, registration, or other activity in response to display of an advertisement. An advertisement exchange server may provide services for advertiser servers to add executable instructions that send notification of conversion from display of an advertisement on a computing device within web page content published by advertiser servers. Instrumentation such as tracking and annotative functions on a client device including segmentation beaconing or engagement tracking for a web page or video advertising leveraging client-side instrumentation can use the mechanism of the present invention for increased security. For instance, segmentation beaconing may use the present invention for annotating particular users for advertisement targeting or retargeting. The present invention may also be used by many websites that track engagement of users with rich media advertisements formats such as videos or flash applications. As will be understood, the various block diagrams, flow charts and scenarios described herein are only examples, and there are many other scenarios to which the present invention will apply.

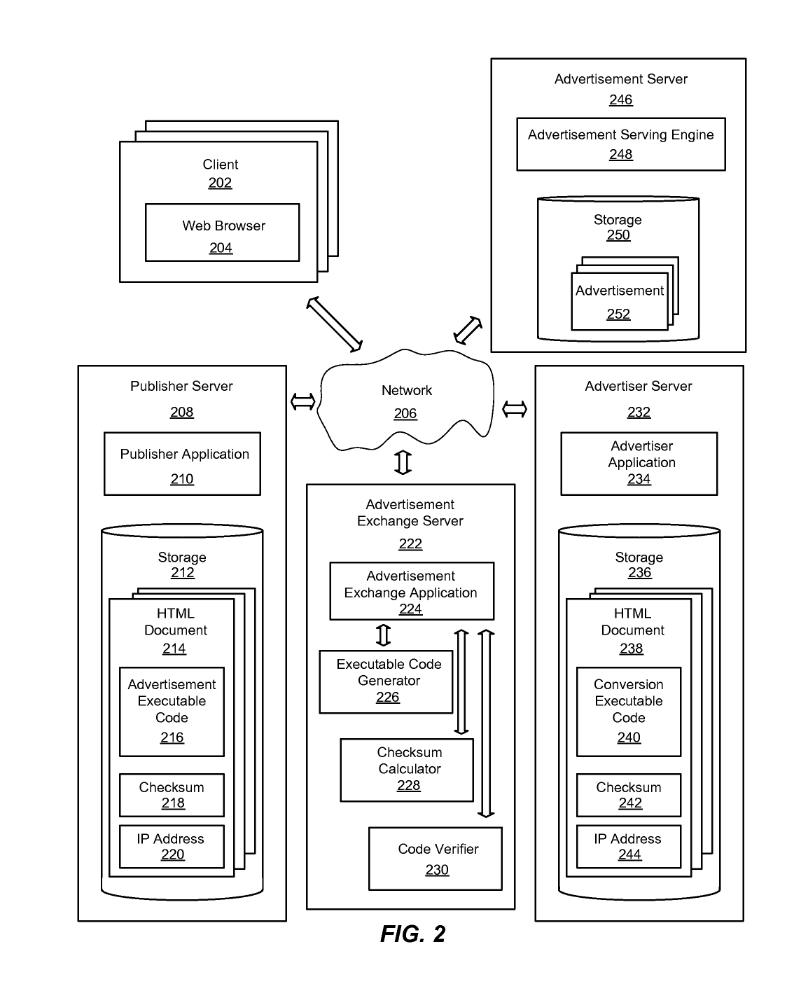

Turning to FIG. 2 of the drawings, there is shown a block diagram generally representing an exemplary architecture of system components for securely serving online advertisements. Those skilled in the art will appreciate that the functionality implemented within the blocks illustrated in the diagram may be implemented as separate components or the functionality of several or all of the blocks may be implemented within a single component. For example, the functionality for the checksum calculator 228 may be included in the same component as the code verifier 230. Or the functionality of the checksum calculator 228 may be implemented as a separate component from the code verifier 230 as shown. Moreover, those skilled in the art will appreciate that the functionality implemented within the blocks illustrated in the diagram may be executed on a single computer or distributed across a plurality of computers for execution. For example, the functionality distributed across the advertiser exchange server 222 and the advertiser server 232 may also be implemented on a single server.

In various embodiments, a client computer 202 may be operably coupled to one or more servers by a network 206, such as publisher server 208, advertisement exchange server 222, advertiser server 232 and advertisement server 246. The client computer 202 may be a computer such as computer system 100 of FIG. 1. The network 206 may be any type of network such as a local area network (LAN), a wide area network (WAN), or other type of network. A web browser 204 may execute on the client computer 202 and may include functionality for receiving a request to fetch a web page which may be input by a user, functionality for sending the request to a server to obtain the web page, and functionality for receiving and displaying the web page to a user. In general, the web browser 204 may be any type of interpreted or executable software code such as a kernel component, an application program, a script, a linked library, an object with methods, and so forth. The web page may be a Hypertext Markup Language (HTML) document or other type of document that may be used to convey multimedia content over the network that may include executable code.

The publisher server 208 may be any type of computer system or computing device such as computer system 100 of FIG. 1. In general, the publisher server 208 may serve web pages with multimedia content and may be operably coupled to storage 212 that includes one or more HTML documents 214 with advertisement executable code 216, a checksum 218 and an Internet Protocol (IP) address 220. The publisher server 208 may include a publisher application 210 that may request and receive advertisement executable code 216 that may be included in an HTML document 214 in order to display advertisements with web page content. The publisher application may also receive a checksum 218 calculated from the binary values of the executable code that may be used to determine if the executable code has changed. The IP address 220 may be populated with the IP address of the publisher server 208. In an embodiment, a publisher server may receive a request to serve an advertisement and may use the checksum to verify that the executable code is valid. The publisher application 210 may be any type of executable software code such as a kernel component, an application program, a linked library, an object with methods, or other type of executable software code.

The advertisement exchange server 222 may be any type of computer system or computing device such as computer system 100 of FIG. 1. In general, the advertisement exchange server 222 may provide services for publisher servers 208 to securely display online advertisements within allocated space of a web page of content published by the publisher servers 208. The advertisement exchange server 222 may include an advertisement exchange application 224 that may receive requests for advertisement executable code 216 and send advertisement executable code 216 that may be included in an HTML document 214 in order to display advertisements with web page content. The advertisement exchange server 222 may also include an executable code generator 226 that provides the advertisement executable code 216 that securely requests and receives advertisements for display within allocated space of a web page of content published by the publisher servers 208. The executable code may be an interpreted script such as JavaScript, Perl or other executable code. The advertisement exchange server 222 may also include a checksum calculator 228 that calculates a checksum 218 from the binary values of the advertisement executable code 216 that may be used to determine if the executable code has changed. The advertisement exchange server 222 may also include a code verifier 230 that validates the checksum 218 of the advertisement executable code 216 and the IP address 220 of the publisher server 208. The components of the advertisement exchange server 222 may be any type of executable software code such as a kernel component, an application program, a linked library, an object with methods, or other type of executable software code.

The advertiser server 232 may be any type of computer system or computing device such as computer system 100 of FIG. 1. In general, the advertiser server 232 may serve web pages with multimedia content and may be operably coupled to storage 236 that includes one or more HTML documents 238 with conversion executable code 240, a checksum 242 and an IP address 244. The advertiser server 232 may include an advertiser application 234 that may request and receive conversion executable code 240 that may be included in an HTML document 238 in order to report conversion of an advertisement impression for instance with sale of a product displayed on a web page. The advertiser application may also receive a checksum 242 calculated from the binary values of the executable code that may be used to determine if the executable code has changed. The IP address 244 may be populated with the IP address of the advertiser server 232. The advertiser application 234 may be any type of executable software code such as a kernel component, an application program, a linked library, an object with methods, or other type of executable software code.

And the advertisement server 246 may be any type of computer system or computing device such as computer system 100 of FIG. 1. In general, the advertisement server 246 may serve advertisements 252 and may be operably coupled to storage 250 that includes one or more advertisements 252. The advertisement server 246 may include an advertisement serving engine 248 that may receive requests to serve advertisements 252 and serve the advertisements 252 for display on a web page. The advertisement serving engine 248 may be any type of executable software code such as a kernel component, an application program, a linked library, an object with methods, or other type of executable software code.

Those skilled in the art will appreciate that many of the components of the computer system 100 and the system components for securely serving online advertisements illustrated in FIG. 2 may be implemented in various embodiments within a system-on-a-chip architecture including memory, external interfaces, the operating system, the search engine and the social information ranking engine. System-on-a-chip implementations are common for special purpose hand-held devices, such as mobile phones, digital music players, personal digital assistants and the like.

An advertisement exchange platform may use the present invention to securely serve online advertisements for publishers and may also use the present invention to track conversion of advertisements such as a purchase, registration, or other activity in response to display of an advertisement. A publisher may allocate space for placement of advertisements in content published on their website for displaying the advertisements. A publisher may sign up for an account on an advertisement exchange platform and may categorize different sections of their website for targeting advertisements that belong to those categories. Alternatively, a web crawler may crawl the publisher's website and a text analyzing system may dynamically categorize different sections of the website. The publisher may receive executable code, such as an advertisement tag, that may be placed at a location of a web page on their web site. When a web browser operating on a client retrieves a web page from the publisher, the executable code may be invoked to request an advertisement be served to the client for display on the web page. In an embodiment, a request to serve an advertisement may be received by a publisher server. In various embodiments, a request to serve an advertisement may be received by an advertisement exchange server. An advertisement exchange platform may then tally impressions shown and user clicks to determine a revenue share for a publisher and the advertisement exchange service.

To securely serve online advertisements, a checksum may be generated when the advertisement tag is created. The checksum may be stored by the advertisement tag ID on the advertisement exchange server. When a client browser retrieves a web page with an advertisement tag from a publisher, the executable code is invoked. The executable code computes the checksum, extracts the publisher's IP address from the http header, extracts the advertisement tag ID, and sends a request to the advertisement exchange server to serve an advertisement. The request may include the checksum, the publisher's IP address, web site the section ID of the website, user information, and the advertisement tag ID. The checksum and publisher's IP address is verified by the advertisement exchange server and the advertisement exchange server sends a request to the advertisement server to serve an advertisement for the category of the website section.

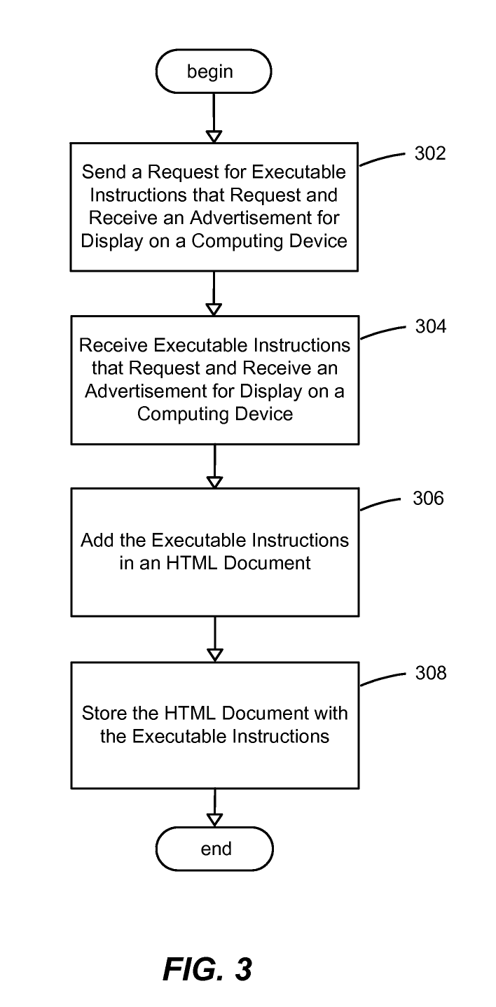

FIG. 3 presents a flowchart for generally representing the steps undertaken in one embodiment for adding executable instructions in a web page for securely serving online advertisements. At step 302, a request may be sent to receive executable instructions that request and receive an advertisement for display on a computing device. In an embodiment, a publisher server may send the request to an advertisement exchange server. At step 304, executable instructions that request and receive an advertisement for display on a computing device may be received with executable instructions to calculate a checksum from the binary values of the executable code. For instance, an advertisement exchange server may send an advertisement tag that includes executable instructions that request and receive an advertisement and includes executable instructions that calculate a checksum from the binary values of the advertisement tag. In an embodiment, an encrypted checksum may also be sent to a publisher server that may receive a request to serve an advertisement to a browser operating on a client. The encrypted checksum may be stored and used to verify that the executable code is valid.

At step 306, executable instructions that request and receive an advertisement for display on a computing device may be added in an HTML document with executable instructions that calculate a checksum from the binary values of the advertisement tag. And the HTML document with the executable instructions may be stored at step 308. In an embodiment, a publisher server may add the executable instructions in an HTML document and store the document on the publisher server.

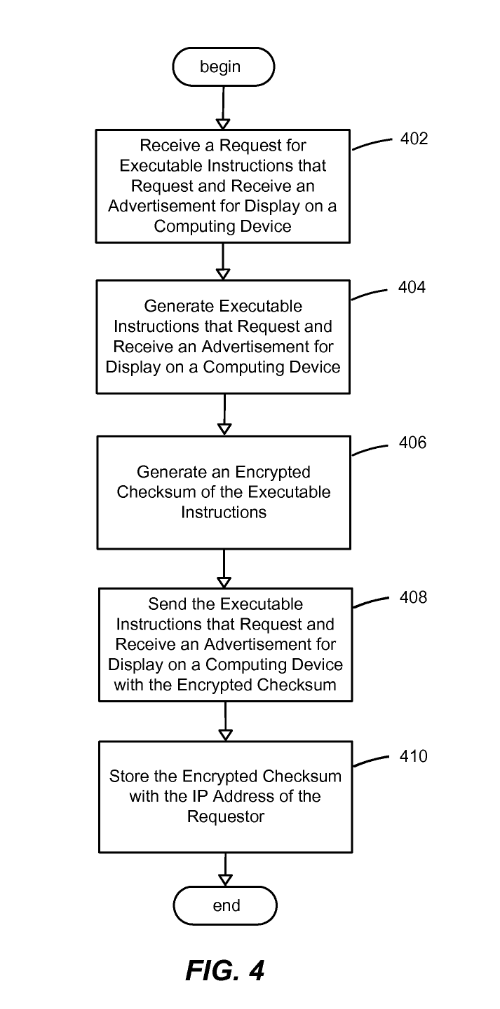

FIG. 4 presents a flowchart for generally representing the steps undertaken in one embodiment for generating executable instructions for a web page to request and receive an advertisement for display on a computing device for securely serving online advertisements. At step 402, a request may be received to send executable instructions that request and receive an advertisement for display on a computing device. For example, an advertisement exchange server may receive a request from a publisher application operating on a publisher server to send an advertisement tag that may be invoked to retrieve an advertisement for display with content of a web page.

At step 404, executable instructions that request and receive an advertisement for display on a computing device may be generated. And an encrypted checksum of the executable instructions may be generated at step 406. In an embodiment, an advertisement exchange server may generate the executable instructions and may calculate the checksum from the binary values of the executable instructions. At step 408, the executable instructions that request and receive an advertisement for display on a computing device may be sent to the requester with the encrypted checksum. And the encrypted checksum may be stored with the IP address of the requester at step 410.

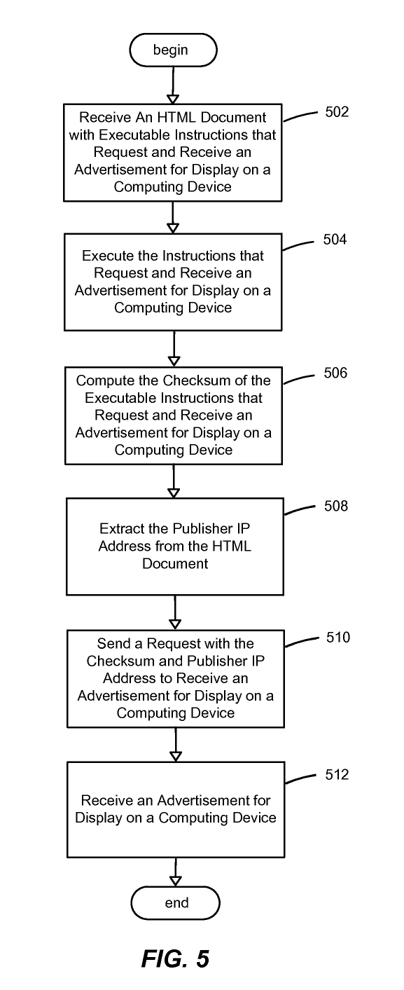

FIG. 5 presents a flowchart for generally representing the steps undertaken in one embodiment for invoking the executable instructions for a web page to request and receive an advertisement for display on a computing device for securely serving online advertisements. At step 502, an HTML document may be received with executable instructions that request and receive an advertisement for display on a computing device. For example, a web browser operating on a client device may retrieve a web page with an advertisement tag from a publisher server.

At step 504, the executable instructions that request and receive an advertisement for display on a computing device may be executed, and the checksum of the executable instructions that request and receive an advertisement for display on a computing device may be computed at step 506. At step 508, the IP address of the publisher may be extracted from the HTML document. In an embodiment, the IP address may be extracted from the http header of the HTML document. At step 510, a request to receive an advertisement for display on a computing device may be sent with the checksum and extracted IP address of the publisher. In an embodiment, an advertisement exchange server may receive the request, verify that the checksum is valid for the internet protocol address of the publisher server, and may send the request to an advertiser server to serve an advertisement to the client device. In another embodiment, a publisher server may receive the request, verify the checksum is valid, and may serve and advertisement to the client device. And at step 512, an advertisement for display on a computing device may be received by the client computing device.

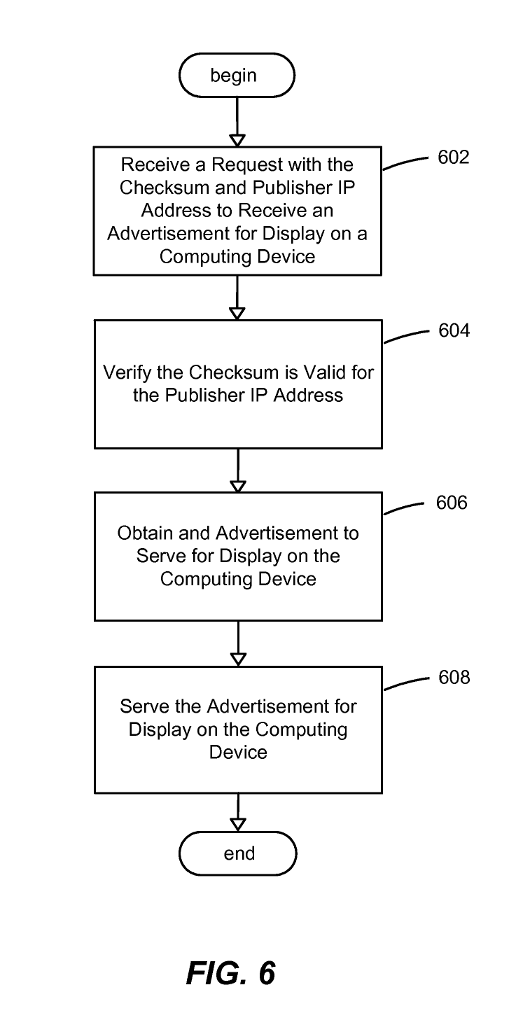

FIG. 6 presents a flowchart for generally representing the steps undertaken in one embodiment for verifying a request to receive an advertisement for display on a computing device is valid for securely serving online advertisements. At step 602, a request to receive an advertisement for display on a computing device may be received with an encrypted checksum and publisher IP address. At step 604, the checksum may be verified to be valid for the publisher IP address. In an embodiment, an advertisement exchange server may store an advertisement tag ID mapped to the publisher IP address and an encrypted checksum. The checksum may be compared with the checksum received to verify that the checksum received is valid. At step 606, an advertisement may be obtained to serve for display on the computing device. In an embodiment, an advertisement exchange server may send the request to an advertiser server to serve an advertisement to the client device. And the advertisement may be served for display on the computing device at step 608.

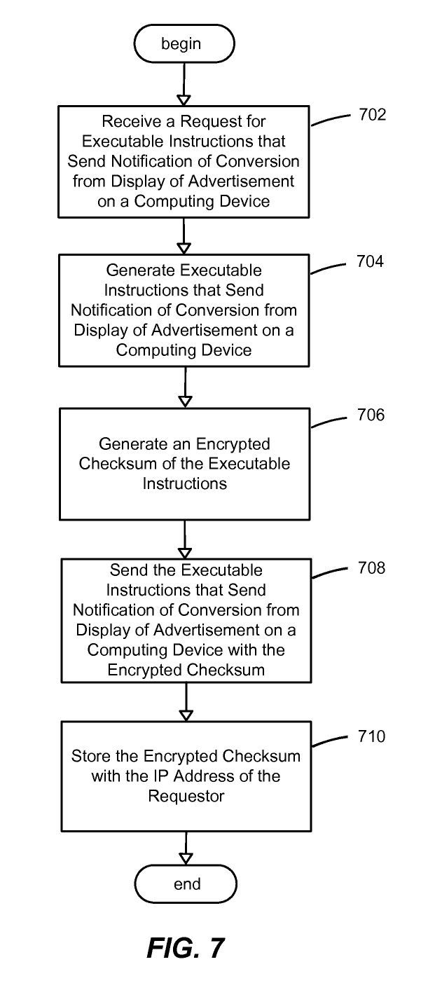

FIG. 7 presents a flowchart for generally representing the steps undertaken in one embodiment for generating executable instructions for a web page to securely send notification of conversion from display of an advertisement on a computing device. At step 702, a request may be received to send executable instructions that send notification of conversion from display of an advertisement on a computing device. For example, an advertisement exchange server may receive a request from an advertiser server to send a conversion tag for a web page of a shopping site. At step 704, executable instructions that send notification of conversion from display of an advertisement on a computing device may be generated. An encrypted checksum of the executable instructions may then be generated at step 706. In an embodiment, the checksum may be calculated from the binary values of the executable instructions.

At step 708, the executable instructions that send notification of conversion from display of an advertisement on a computing device may be sent to the requester with the encrypted checksum. For instance, the advertisement exchange server may send the conversion tag with the executable instructions for calculating a checksum to the advertiser server. And at step 710, the encrypted checksum may be stored with the IP address of the requester.

An advertisement server may then add the conversion tag in an HTML document to send notification of conversion from display of an advertisement on a computing device within web page content published by advertiser servers. When a client device may retrieve the web page and execute the instructions of the conversion tag, a notification may be sent to an advertisement exchange server that may verify that the checksum is valid for the internet protocol address of the advertiser server, and may record the conversion.

Thus the present invention may be used by an advertisement exchange platform to securely serve online advertisements for publishers and to track conversion of advertisements such as a purchase, registration, or other activity in response to display of an advertisement. Advantageously, the system and method may efficiently identify that an advertisement tag is unchanged and originates from a valid publisher. Thus, it may prevent unintended uses of advertisement tags such as false calls for advertisements or false notifications of conversions. Moreover, then mechanism of the present invention may be used to secure invocations of executable instructions including instrumentation in online advertising platforms. Various tracking and annotative functions on a client device including segmentation beaconing or engagement tracking for a web page or video advertising leveraging client-side instrumentation can use the mechanism of the present invention for increased security. Importantly, the system and method may promote revenue generation by providing a more secure advertisement exchange platform for publishers, advertisers, and advertisement exchange platforms.

As can be seen from the foregoing detailed description, the present invention provides an improved system and method for securely serving online advertisements. An advertisement exchange server may provide services for publisher servers to add executable instructions to a document that may calculate a checksum to validate the executable instructions. A client device may then retrieve the document, and the executable instructions may calculate a checksum from the binary values of the executable instructions, extract the internet protocol address of the publisher server, and send a request with the checksum and internet protocol address of the publisher server to receive the advertisement. The advertisement exchange server may receive the request from the client device and verify that the checksum is valid for the internet protocol address of the publisher server by comparing the checksum received with the checksum stored for the internet protocol address of the publisher server. The advertisement exchange server may then process the request. As a result, the system and method provide significant advantages and benefits needed in contemporary computing, and more particularly in online advertising applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A distributed computer system for online advertising, comprising:
a plurality of publisher servers, each publisher server having a publisher application that requests and receives executable instructions for inclusion in a document that calculate a checksum to validate the executable instructions and retrieve an advertisement to display with content of the document;
a client device operably connected to the plurality of publisher servers for retrieving the document and invoking the executable instructions that calculate the checksum to validate the executable instructions and retrieve the advertisement to display with content of the document; and
a network operably coupled to the client device and operably coupled to the plurality of publisher servers for communicating a request from the client device to retrieve the document with the executable instructions that calculate the checksum to validate the executable instructions and retrieve the advertisement to display with content of the document.

2. The system of claim 1 further comprising a server operably coupled by the network to the plurality of publisher servers, the server having an application that provides the executable instructions for inclusion in the document that calculate the checksum to validate the executable instructions and retrieve the advertisement to display with content of the document.

3. The system of claim 2 wherein the server is operably coupled by the network to the client device, the server having a code verifier that receives the checksum calculated by the executable instructions and verifies the checksum calculated by the executable instructions is valid for the internet protocol address of a publisher server of the plurality of publisher servers.

4. The system of claim 1 further comprising an advertising server to serve the advertisement to display with content of the document.

5. The system of claim 1 further comprising a plurality of advertiser servers, each advertiser server having an advertiser application that requests and receives a second plurality of executable instructions for inclusion in a second document that calculate a second checksum to validate the second plurality of executable instructions and send notification of conversion of the advertisement displayed with content of the document.

6. A computer-implemented method for online advertising, comprising:
receiving from a requester a request to provide executable instructions for inclusion in a document;
generating the executable instructions for inclusion in the document with instructions that calculate a checksum to validate the executable instructions;
calculating a first checksum of the executable instructions;
storing the first checksum of the executable instructions for an internet protocol address of the requester; and
sending to the requester the executable instructions for inclusion in the document that calculate the checksum to validate the executable instructions.

7. The method of claim 6 further comprising encrypting the first checksum of the executable instructions.

8. The method of claim 6 further comprising sending the request to provide executable instructions for inclusion in the document that retrieve an advertisement to display with content of the document.

9. The method of claim 6 further comprising adding the executable instructions in the document and storing the document.

10. The method of claim 6 further comprising receiving the document with executable instructions that calculate the checksum to validate the executable instructions and retrieve an advertisement to display with content of the document.

11. The method of claim 10 further comprising executing the executable instructions that calculate the checksum to validate the executable instructions and retrieve the advertisement to display with content of the document.

12. The method of claim 11 further comprising:
calculating a second checksum;
extracting an internet protocol address of the requester from the document; and
sending a request with the second checksum and internet protocol address of the requester to retrieve the advertisement to display with content of the document.

13. The method of claim 12 further comprising receiving the request with the second checksum and internet protocol address of the requester to retrieve the advertisement to display with content of the document.

14. The method of claim 13 further comprising verifying that the second checksum is valid for the internet protocol address of the requester by comparing the second checksum for the internet protocol address of the requester with the first checksum for the internet protocol address of the requester.

15. The method of claim 14 further comprising obtaining the advertisement to display with content of the document.

16. The method of claim 15 further comprising sending the advertisement to display with content of the document.

17. The method of claim 16 further comprising:
receiving notification of conversion of the advertisement displayed with content of the document, the notification including a third checksum for a second internet protocol address; and
verifying that the third checksum is valid for the second internet protocol address.

18. A computer-readable medium having computer-executable instructions for performing the method of claim 6.

19. A distributed computer system for online advertising, comprising:
means for receiving from a requester a request to provide executable instructions for inclusion in a document that retrieve an advertisement to display with content of the document;
means for generating the executable instructions for inclusion in the document that retrieve the advertisement to display with content of the document and that calculate a checksum to validate the executable instructions;
means for storing a first checksum of the executable instructions for an internet protocol address of the requester; and
means for sending to the requester the executable instructions for inclusion in the document that calculate the checksum to validate the executable instructions and retrieve the advertisement to display with content of the document.

20. The computer system of claim 19 further comprising:
means for receiving the request with a second checksum and internet protocol address of the requester to retrieve the advertisement to display with content of the document;
means for verifying that the second checksum is valid for the internet protocol address of the requester; and
means for sending the advertisement to display with content of the document.
